(19) United States
(12) Patent Application Publication
(10) Pub. No.: US 2004/0160159 A1
(43) Pub. Date: Aug. 19, 2004

(54) Color display tube with selection electrode

(76) Inventors: Arnoldus Antonius Maria Hendriks, Eindhoven (NL); Theodoor Christiaan Anna Hens, Eindhoven (NL); Wilhelmus Marinus Maria Van De Steen, Eindhoven (NL); Ludovic Peter Willem Huysmans, Eindhoven (NL); Jean Winters, Eindhoven (NL)

Correspondence Address: Corporate Patent Counsel, Philips Electronics North America Corporation, P O Box 3001, Briarcliff Manor, NY, 10510, US

(21) Appl. No.: 10/480,416

(22) PCT Filed: Jun. 17, 2002
(86) PCT No.: PCT/IB02/02319

(30) Foreign Application Priority Data
Jun. 21, 2001 (EP) 012024097

(51) Int. Cl. H01J 29/80

(52) U.S. Cl. 313/402

(57) ABSTRACT

In present day color display tubes (1) the microphony performance of the shadow mask (13) is becoming increasingly important, especially in color display tubes (1) with a flat or nearly flat outer side of the display window (3). This invention discloses a mask frame (14) which by means of the transfer of vibrations from the outside of the color display tube (1) to the shadow mask (13) is hampered. This makes the shadow mask (13) less sensitive to vibrations, leading to an improved performance with respect to color purity. This object is achieved by providing the diaphragm parts (15), which form a part of the mask frame (14), with indents (27). Preferably, the skirt (19) of the shadow mask (13) is connected to the diaphragm part 15 by providing one spot weld (28) in between each pair of adjacent indents (27).

The invention relates to a color display tube comprising a color selection electrode having a shadow mask and a frame with corner sections and diaphragm parts which are coupled to the corner sections.

The invention further relates to a color selection electrode for use in such a color display device and to a diaphragm part for use in said color selection electrode.

A color display tube as described in the opening paragraph is disclosed in U.S. Pat. No. 5,003,218. The color display tube according to this specification is provided with a color selection electrode having a frame consisting of four diaphragm parts and four corner sections, suspended in the corners of a display window.

The color display tube described in U.S. Pat. No. 5,003,218 is provided with a color selection electrode to ensure that electron beams originating from three electron guns, mounted in a neck portion of the tube, only excite one color of electroluminescent material on the inner side of the display window. This color selection is achieved by applying, for instance, a shadow mask in the tube. This shadow mask comprises a large number of apertures, in most cases arranged in either a slotted pattern or a dotted pattern. If the color selection electrode is not stably positioned in the color display tube, small deviations of its position will lead to a deterioration of the picture quality. If, for instance, the color selection electrode is slightly deformed, the shadowing effect of the color selection electrode changes and hence the electron beams do not hit the appropriate electroluminescent material on the display window. These registration errors cause discoloration of the display tube that lead to a deterioration of the quality of the picture on the color display tube.

The color display tube in accordance with the prior art has the disadvantage that the shadow mask is rather sensitive to microphony. Due to external shocks the shadow mask may vibrate, causing registration errors, leading to variations in brightness and color purity.

It is an object of the invention to provide a color display tube having a color selection electrode with an improved color purity relative to the type described in the opening paragraph, as a result of which registration errors on the display window are reduced substantially.

According to the present invention, this object is achieved with a color display tube which is characterized in that the diaphragm parts have a side extending in the direction of the display window, which side is provided with a plurality of indents. The invention is based on the insight that a reduction of the registration errors is achieved when the positional stability of the shadow mask with respect to the frame of the color selection electrode is improved. This can be realized by providing the edge of the diaphragm part that points towards the screen with a certain number of indents. As these indents will weaken the edge of the diaphragm part to which the shadow mask is mounted it will become more difficult to transfer shocks to the shadow mask. As a consequence the shadow mask will be less susceptible to vibrations and the color picture performance is improved: the color display tube will show fewer variations in brightness and color purity.

A preferred embodiment of the color display tube according to the present invention is characterized in that, the shadow mask further comprises a skirt which is coupled to each diaphragm part by a plurality of spot welds. External shocks that lead to vibrations of the frame of the color selection electrode are less easily transferred to the shadow mask itself when the connection between the shadow mask and the diaphragm parts is not too strong. For that reason, the skirt, that is the part of the shadow mask that is coupled to the diaphragm part, should be connected to the diaphragm part by using spot welds.

In a further embodiment only one spot weld is present between two adjacent indents.

With respect to the microphony performance of the shadow mask, this embodiment yields good results because between two spot welds there is one indent, as a result of which a vibration of the diaphragm part can be absorbed. In the situation where two spot welds are not separated by an indent, a vibration can be transferred to the shadow mask much more easily.

In a still further embodiment, the number of spot welds on each diaphragm part is one below the number of indents on said diaphragm part.

This embodiment ensures that there are no spot welds between the end of the diaphragm part and the first indent, viewed from said end.

In Japanese Patent Application JP-4-155730, a mask frame is disclosed which is provided with grooves that show some resemblance with the indents of the present invention. According to this Japanese Patent Application, the mask frame is a heavy frame of a thick soft steel material with a relatively high thermal expansion coefficient. The shadow mask, which is made of an invar material having a low thermal expansion coefficient, is welded to the mask frame. The difference in thermal expansion coefficient leads to problems in the heat treatment process during the production of the color display tube. For that reason, the edge of the mask frame to which the shadow mask is welded is provided with grooves in order to prevent serious deformations of the mask during processing. Between two grooves more than one weld is visible.

This is in sharp contrast with the present invention, in which the mask frame comprises four diaphragm parts which are formed from a thin and light material and which are coupled to the corner sections. To make sure that there is hardly any difference in thermal expansion coefficient between the shadow mask and the diaphragm parts, both are made from the same material, for instance invar. The basic idea of the present invention is found in the recognition that the microphony behavior of the color display tube can be improved by providing the diaphragm parts with indents and welding the shadow mask to these diaphragm parts in such a manner that there is one spot weld between two adjacent indents.

The invention also relates to the color selection electrodes and the diaphragm parts used in a color display tube according to the invention.

These and other aspects of the invention will be apparent from and will be elucidated by way of non-limitative examples with reference to the embodiments described hereinafter.

In the drawings:

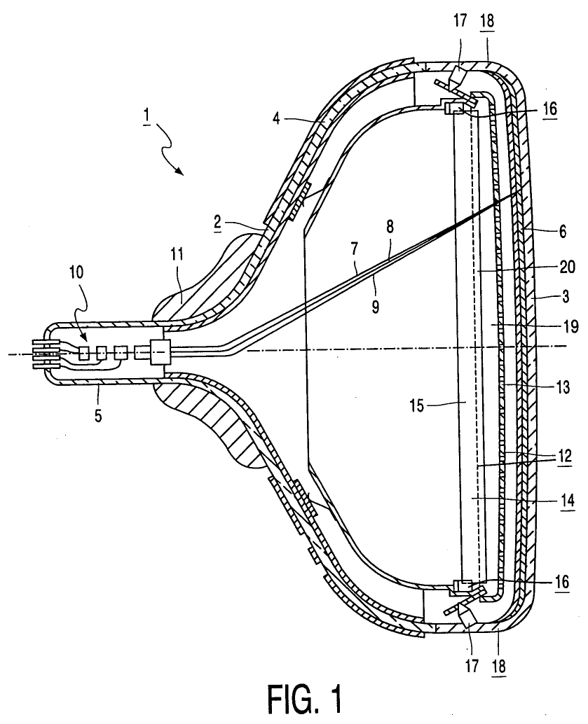

FIG. 1 is a sectional view of a color display tube according to the invention;

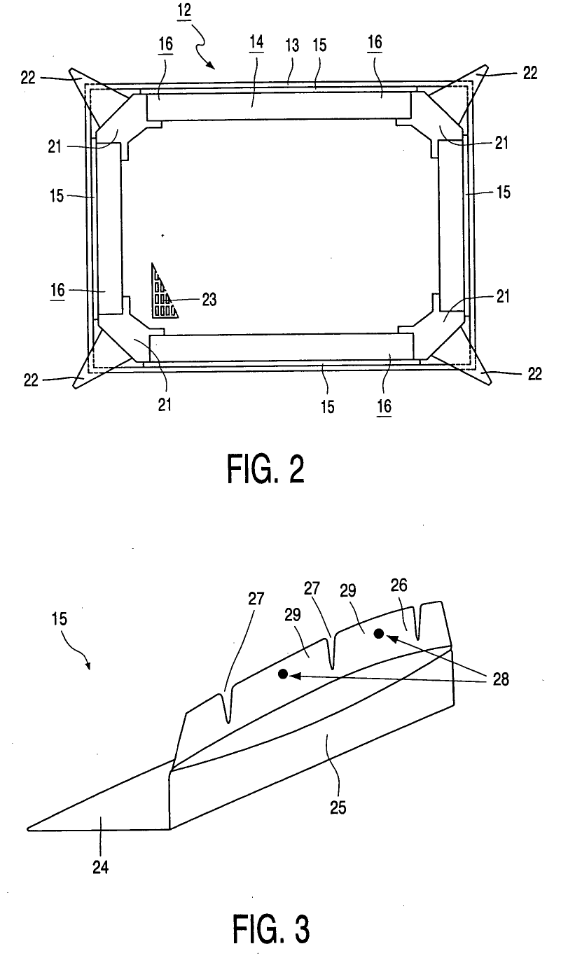

FIG. 2 is an elevational view of a color selection electrode to be mounted in the tube of FIG. 1;

FIG. 3 is a schematic example of a diaphragm part according to the invention.

The color display tube 1 shown in FIG. 1 comprises an evacuated glass envelope 2 with a display window 3, a funnel shaped part 4 and a neck 5. On the inner side of the display window 3 a screen 6 having a pattern of for example lines or dots of phosphors luminescing in different colors (e.g. red, green and blue) may be arranged. The phosphor pattern is excited by the three electron beams 7, 8 and 9 that are generated by the electron gun 10. On their way to the screen the electron beams 7, 8 and 9 are deflected by the deflection unit 11 ensuring that the electron beams 7, 8 and 9 systematically scan the screen 6.

Before the electrons hit the screen 6 they pass through a color selection electrode 12. This color selection electrode 12 comprises a shadow mask 13, which is the real color-selective part: it intersects the electron beams so that the electrons only hit the phosphor of the appropriate color. The shadow mask 13 may be an apertured mask having circular or elongated apertures, or a wire mask. Furthermore, the color selection electrode 12 comprises the frame 14 for supporting the shadow mask 13. Parts that can be distinguished in the frame 14 are, amongst others, the corner sections 16 and the diaphragm parts 15 interconnecting the corner sections 16. In general, the shadow mask 13 is provided with an upright edge—referred to as the skirt 19 of the shadow mask 13—which is coupled to the diaphragm part 15 in the overlapping region 20.

The color selection electrode 12 is suspended from the display window 3 by using supporting elements 17, which are secured in the upright edge of the corner areas 18 of the display window 3. This way of suspending the color selection electrode 12 in a color display tube 1 will hereinafter be referred to as corner suspension.

In FIG. 2 an elevational view of a color selection electrode 12 is given. The corner sections 16 in this Figure comprise two major portions, a rigid portion 21 for interconnecting the diaphragm parts 15 and a suspension element 22 for suspending the color selection electrode 12 from the display window 3. The shadow mask 13 is coupled to the diaphragm parts 15. The section 23 of the mask, as indicated in FIG. 2, is only meant as an example.

FIG. 3 shows an example of a diaphragm part 15 according to the invention. This diaphragm part 15 has a side 24 which is more or less parallel to the display window 3 and a side 25 extending in the direction of the display window 3, substantially perpendicularly to side 24. Side 25 is shaped so as to properly receive the contour of the skirt 19, which is of particular importance when the shadow mask 13 is curved. The edge 26 of side 25 is connected to the skirt 19, most commonly by welding, for instance a certain number of spot welds.

According to the invention, the edge 26 is provided with a number of indents 27. Preferably the skirt 19 is then welded to the diaphragm parts 15 in such a manner that there is one spot weld 28 in between each pair of adjacent indents 27. This construction has the advantage that in case the color display tube 1 is exposed to external shocks or vibrations, these are better absorbed, and as a consequence the shadow mask 13 itself will show less vibrations. The diaphragm part 15 and more specifically the edge 26 is weakened by adding the indents 27 to said edge 26. As a result, with respect to vibrations there is less coupling between adjacent zones 29 separated by an indent 27 of the edge 26, so that the transfer of vibrations between these zones 29 and consequently to the shadow mask 13 is hampered. In order to limit the transfer of vibrations from one zone 29 to the shadow mask 13, it is required that the shadow mask 13 is not too tightly connected to each zone 29; for that reason it is preferred to have only one spot weld 28 per zone 29. The best results are obtained when there is no weld between the last indent 27 and the end of the edge 26.

The use of a diaphragm part 15 according to the invention leads to a better picture performance because it limits vibrations of the shadow mask 13, which vibrations may cause misregistration of the electron beams 7, 8, 9 passing through the shadow mask 13. In general, misregistrations of an electron beam 7, 8, 9 on the phosphor layers of the screen 6 cause discoloration and even a lack of luminance.

In practice, this way of constructing diaphragm parts 15 and connecting the shadow mask 13 to them additionally shows a better behavior with respect to overall doming. During operation, the shadow mask 13 becomes hotter than the diaphragm parts 15, leading to an expansion of the skirt 19 that exceeds than that of the edge 26. As a result, the contour of the shadow mask will change, which leads also to misregistrations. The use of a diaphragm part 15 according to the invention enables the difference in expansion between skirt 19 and edge 26 to be compensated for much more readily by virtue of the presence of the indents 27, so that the contour of the shadow mask hardly changes.

Depending on the type of color display tube 1—like the size of the display window 3, the aspect ratio, the choice of material of which the shadow mask 13 and the diaphragm parts 15 are made—it is a matter of proper design work to determine the location and number of indents 27, the dimensions—width and depth—of these indents 27 and the location of the spot welds 28 with respect to these indents 27.

It goes without saying that the example of FIG. 3, having three indents 27 and two spot welds 28 is merely illustrative of the invention and should not be considered as limitative.

In summary, in present day color display tubes 1 the microphony performance of the shadow mask 13 is becoming increasingly important, especially in color display tubes 1 with a flat or nearly flat outer side of the display window 3. This invention discloses a mask frame 14 by means of which the transfer of vibrations from the outside of the color display tube 1 to the shadow mask 13 is hampered. This makes the shadow mask 13 less sensitive to vibrations, leading to an improved performance with respect to color purity. This object is achieved by providing the diaphragm parts 15, which form a part of the mask frame 14, with indents 27. Preferably, the skirt 19 of the shadow mask 13 is connected to the diaphragm part 15 by providing one spot weld 28 in between each pair of adjacent indents 27.

1. A color display tube (1) comprising a color selection electrode (12) having a shadow mask (13) and a frame (14) with corner sections (16) and diaphragm parts (15) which are coupled to the corner sections (16), characterized in that the diaphragm parts (15) have a side (25) that extends in the direction of the display window (3) and is provided with a plurality of indents (27).

2. A color display tube (1) as claimed in claim 1, characterized in that, the shadow mask (13) further comprises a skirt (19) which is coupled to each diaphragm part (15) by a plurality of spot welds (28).

3. A color display tube (1) as claimed in claim 2, characterized in that only one spot weld (28) is present between two adjacent indents (27).

4. A color display tube (1) as claimed in claim 3, characterized in that the number of spot welds (28) on each diaphragm part (15) is one below the number of indents (27) on said diaphragm part (15).

5. A color selection electrode (12) for use in the color display tube (1) of one of the preceding claims.

6. A diaphragm part (15) for use in the color selection electrode (12) of claim 5.
